(19) United States
(12) Patent Application Publication
(10) Pub. No.: US 2026/0014802 A1
(43) Pub. Date: Jan. 15, 2026

(54) SYSTEMS AND METHODS FOR DYNAMICALLY MODIFYING DIGITAL IMAGES BASED ON INK AND PRINTING CHARACTERISTICS

(71) Applicant: ELECTRONICS FOR IMAGING, INC, Londonderry, NH (US)

(72) Inventors: Manuel ESCUDERO VERCHILI, Almazora (ES); Ignacio RUIZ DE CONEJO, Almazora (ES)

(21) Appl. No.: 19/267,540

(22) Filed: Jul. 12, 2025

(30) Foreign Application Priority Data
Jul. 12, 2024 (ES) P202430591

(51) Int. Cl. B41J 2/21; B41J 11/00

(52) U.S. Cl. CPC B41J 2/2132; B41J 11/00214

(57) ABSTRACT

Systems and methods for dynamically modifying digital images based on ink and printing characteristics for printable images are disclosed. In some embodiments, a method includes obtaining a digital source image, identifying one or more modification areas including a plurality of pixels where each pixel is correlated with one or more ink drops, determining an expected ink spreading value of each of the ink drops based at least in part on the color of the ink drops, modifying the plurality of pixels, and modifying the correlated ink drops. In some embodiments, the expected ink spreading value is based at least in part on the distance between ink channels and a curing station, the speed of the printing conveyor, the type of printing substrate, and the time each ink drop spends uncured on a printing substrate.

### CROSS-REFERENCE TO RELATED APPLICATIONS

This application claims the benefit of Spain Application No. 202430591 filed Jul. 12, 2024, the content of which is incorporated in its entirety.

### FIELD OF THE INVENTION

This description relates generally to systems and methods of inkjet printing, specifically preparing images for inkjet printing.

### BACKGROUND

Inkjet technology continues to grow and change each year, including the types of inks that are commercially applied, increasing the speed of printing processes, and decreasing the size of printing apparatuses. In particular, water-based inks have gained in popularity for many digital printing applications due to their ecological, health and safety, economic, and profitability advantages compared to conventional inks. However, using water-based inks involves certain challenges that may require different printing processes or systems compared to conventional inkjet printing, particularly when applied to modern printing speeds and apparatuses. For example, water-based ink drops can exhibit particularly problematic instances of dot gain. Dot gain is the expansion or increase in the size of ink drops between the time they are jetted on a substrate and the time they are dried or cured. Excessive or uncontrolled dot gain can produce texts and images that are undesirably colored, have low levels of detail, and exhibit undesired patterns. Thus, solutions are needed to mitigate or compensate for dot gain, particularly as applied to modern printing technologies.

### BRIEF DESCRIPTION OF THE DRAWINGS

FIG. 1 is an illustration of the effects of dot gain, in accordance with one or more embodiments.

FIG. 2 illustrates a perspective view of a printing system, in accordance with one or more embodiments.

FIG. 3 illustrates a side view of a printing system, in accordance with one or more embodiments.

FIG. 4 is a flowchart of an example method of modifying a digital source image to obtain a printed image, in accordance with one or more embodiments.

FIG. 5 is a block diagram illustrating a computer system to control an inkjet printing system, in accordance with one or more embodiments.

### DETAILED DESCRIPTION

Systems and methods for dynamically modifying digital images based on ink and printing characteristics for printable images are disclosed. In some embodiments, a method includes obtaining a digital source image, identifying one or more modification areas including a plurality of pixels where each pixel is correlated with one or more ink drops, determining an expected ink spreading value of each of the ink drops based at least in part on the color of the ink drops, modifying the plurality of pixels, and modifying the correlated ink drops. In some embodiments, the efficacy of the modification with regard to creating a uniform ink spreading pattern is determined and used to update the expected ink spreading values. In some embodiments, the expected ink spreading value is based at least in part on the distance between ink channels and a curing station, the speed of the printing conveyor, the type of printing substrate, and the time each ink drop spends uncured on a printing substrate.

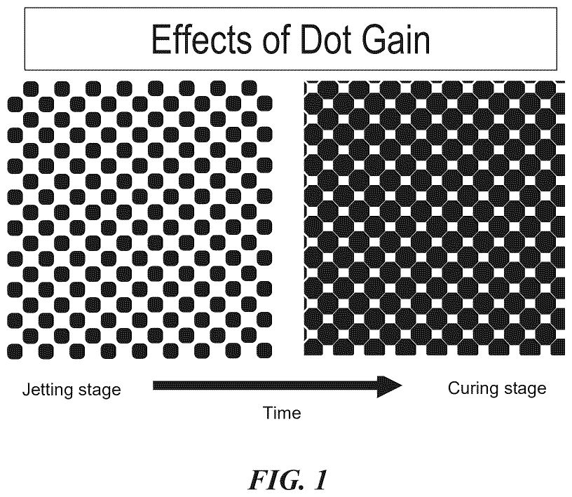

Water-based inks have gained popularity in the inkjet printing industry due to their ecological, health and safety, economic, and profitability advantages compared to conventional inks. However, one challenge with using water-based inks is managing dot gain. As demonstrated in FIG. 1, when ink drops (also referred to as dots) are deposited on a substrate (also referred to as “jetting”), the ink drops grow/spread between the time the ink is jetted and the time it is cured. The amount that each particular ink drop grows depends on a number of characteristics, including the color of the ink, the distance between the jetting and drying stages, the absorption into the substrate, the time between jetting and drying, etc. One problem associated with dot gain is that different color ink drops exhibit different amounts of dot gain relative to each other. For example, for a given amount of time between jetting and curing, a cyan ink drop may expand to approximately four times its initial drop size, while a black ink drop may expand to approximately two times its initial drop size. This lack of uniformity in dot gain creates undesirable coloration, lowers the level of detail of the images, and can give rise to unwanted color or tonal patterns. The difference in dot gain between colors can be particularly pronounced for images that involve many colors and/or images that involve a fine level of detail. Furthermore, in certain modern applications, such as mechanisms involving high printing speeds and relatively small printing apparatuses (which may reduce the distance/time between the jetting and the curing stages), the difference in dot gain between different colors is further exacerbated.

In inkjet printing, digital images on a computer or electronic database are often converted to a rasterized image format in order to prepare the image for printing. Rasterization is the process of taking an image described in a vector graphics format (e.g., as one or more shapes) and converting it into a series of discrete grid units (e.g., pixels, dots, lines, etc.). Each grid unit can contain information specific to the unit, such as location, color, or size. Inkjet printing systems use the information contained in the grid units of rasterized images to determine (among other things) which ink channel will deposit (e.g., jet) each ink drop of the image, the location of each ink drop, and the size of each ink drop. After rasterization, but prior to jetting, various aspects of the rasterized image can be modified to achieve desired effects in the printed image. For example, a continuous gradient-like effect can be achieved by modifying the size and/or spacing of pixels that form the edges of an object, graphic, image, or text. Such methods of modification (or “correction”) are often referred to as generating or creating a “halftone.”

The present technology employs modification schemes (e.g., halftoning) to modify digital images (e.g., rasterized images) to overcome the challenges of dot gain. The present technology generates a modification for each ink channel based on one or more ink and/or printing apparatus characteristics. For example, in some embodiments, the modification is generated based on the color of the ink for a given ink channel. In additional embodiments, printing characteristics, such as conveyor belt speed and/or absorption of the substrate, are used to generate the modification. In some embodiments, the efficacy of the modification with regard to modifying (e.g., mitigating or eliminating) dot gain is determined and used to update the expected dot gain and/or update the modification generated for each ink channel.

The advantages and benefits of the systems and methods described herein include establishing uniform drop spreading across all ink channels (e.g., establishing uniformity between colors) to mitigate or eliminate the problems associated with dot gain. For example, by maintaining uniformity of drop spreading, the disclosed technology facilitates higher levels of image detail and reduces the likelihood of undesirable patterns or colorations arising from uncontrolled dot gain.

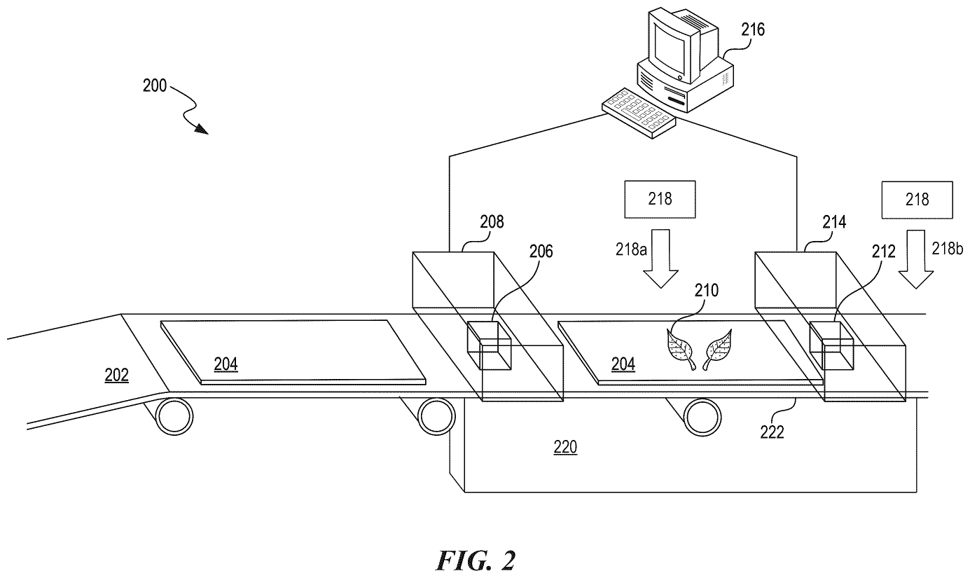

FIG. 2 illustrates a perspective view of a printing system 200, in accordance with one or more embodiments. The printing system 200 includes a printer head 206, at least one light source 212, and a substrate transportation system 202. Embodiments may include various combinations of these and other components—e.g., a dryer. For example, the light source 212 may be present in some embodiments but not in others. As another example, a dryer may be included if an image 210 will not be quickly transferred to a substrate. The substrate transportation system 202 can include a belt, actuators, pulleys, etc. to move the substrate. While the printing system 200 of FIG. 2 can include a transfer belt, other means for conveying and/or retaining a substrate or transfer material 204 can also be used, such as a rotating platform or stationary bed.

The printer head 206 is configured to deposit ink onto a substrate or the transfer material 204 in the form of an image 210. The transfer material 204, which may also be referred to as a former material, is flexible, which allows the image 210 to be transferred to complex-shaped substrates. For example, the transfer material 204 may be a rubber former, a thermoformable material, etc. In some embodiments, the printer head 206 is an inkjet printer head that jets ink onto the substrate or the transfer material 204 using, for example, piezoelectric nozzles. Thermal printer heads are generally avoided in an effort to avoid premature sublimation of the ink. In some embodiments, the ink is a solid energy—e.g., UV-curable ink. However, other inks may also be used, such as water-based energy-curable inks or solvent-based energy-curable inks. The ink can be deposited in different forms, such as ink droplets and colored polyester ribbons.

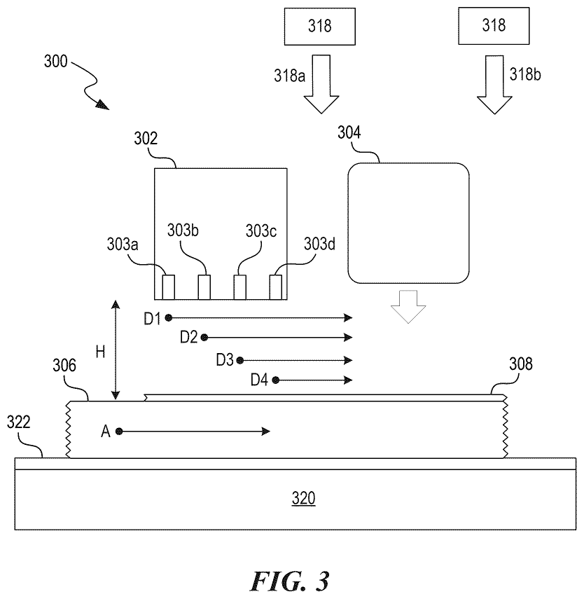

In some embodiments, one or more light sources 212 cure some or all of the ink deposited onto the substrate or the transfer material 204 by emitting UV radiation. The light source(s) 212 may be, for example, a UV fluorescent bulb, a UV light-emitting diode (LED), a low-pressure, e.g., mercury (Hg), bulb, or an excited dimer (excimer) lamp and/or laser. Various combinations of these light sources could be used. For example, a printing system 200 may include a low-pressure Hg lamp and a UV LED. As discussed in more detail with reference to FIG. 3, the light source 212 may be configured to emit UV radiation of a particular subtype.

The printer head 206 and light source 212 are illustrated as being directly adjacent to one another—i.e., neighboring without any intervening components. However, additional components that assist in printing, curing, etc. may also be present. For example, multiple distinct light sources 212 may be positioned behind the printer head 206. FIG. 2 illustrates one possible order in which components may be arranged in order to print an image 210 onto the substrate or the transfer material 204. Other embodiments are considered in which additional components are placed before, between, or after the illustrated components, etc.

In some embodiments, one or more of the aforementioned components are housed within one or more carriages. For example, the printer head 206 can be housed within a printing carriage 208, the light source 212 can be housed within a curing carriage 214, etc. In addition to protecting the components from damage, the carriages may also serve other benefits. For example, the curing carriage 214 can limit what portion(s) of the transfer material 204 and image 210 are exposed during the curing process. The printing system 200 may include pulleys, motors, rails, and/or any combination of mechanical or electrical technologies that enable the carriages to travel along the substrate transportation system (e.g., the transfer belt 202), i.e., with respect to the substrate or the transfer material 204. The transfer belt 202 is affixed to a vacuum table 220 and moves over a vacuum platen 222 that is on top of the vacuum table 220. In alternative embodiments, the carriages can be fixedly attached to a rail or base of the printing system 200. In these embodiments, the transfer material 204 can be moved in relation to the printer head 206, light source 212, etc. such that ink can be deposited onto the transfer material 204.

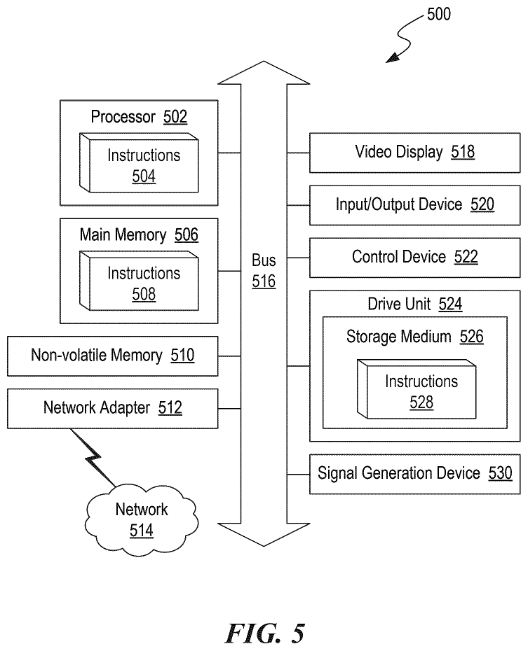

In various embodiments, some or all of the components are controlled by a computer system 216. The computer system 216 is the same as or similar to the computer system 500 illustrated and described in more detail with reference to FIG. 5. The computer system 216 can allow a user to input printing instructions and information, modify print settings, e.g., by changing cure settings, alter the printing process, etc.

FIG. 3 illustrates a side view of a printing system 300, including a printer head 302 and a light source 304, in accordance with one or more embodiments. While a single-pass configuration is illustrated by FIG. 3, other embodiments may employ multi-pass, i.e., scan, configurations. Similarly, embodiments can be modified for various printers—e.g., a flatbed printer, drum printer, or lane printer. For example, a flatbed printer may include a stable bed and a traversing printer head, a stable printer head and a traversing bed, etc. A substrate transportation system is affixed to a vacuum table 320 and moves over a vacuum platen 322 that is on top of the vacuum table 320.

The printer head 302 can include distinct ink/color channels, e.g., cyan 303a, magenta 303b, yellow 303c, and black 303d (CMYK), or colored polyester ribbons that are deposited onto the surface of a transfer material 306. Path A represents the media feed direction, e.g., the direction in which the substrate or the transfer material 306 travels during the printing process. Path H represents the height between the printer head 302 and the surface of the transfer material 306. Paths D1-D4 represent the distance that ink deposited (e.g., jetted) by each of the ink/color channels travels before reaching a light source 304. For example, ink deposited by ink channels for cyan 303a travels a distance D1 before reaching the light source 304, while ink deposited by ink channels for black 303d travels a distance D4 before reaching light source 304, where D1 is greater than D4. In some embodiments, the ink deposited by each of the ink/color channels travels a different distance (e.g., D1, D2, D3, and D4 are all different distances). In additional embodiments, the ink deposited by each of the ink/color channels travels approximately the same distance (e.g., D1, D2, D3, and D4 are approximately the same distance). Any combination of distances and or ink channels/colors is contemplated.

In some embodiments, the light source 304 cures some or all of the ink 308 deposited onto the substrate or the transfer material 306 by the printer head 302. The light source 304 may be configured to emit wavelengths of UV electromagnetic radiation of subtype V (UVV), subtype A (UVA), subtype B (UVB), subtype C (UVC), or any combination thereof. Generally, UVV wavelengths are those wavelengths measured between 395 nanometers (nm) and 445 nm, UVA wavelengths measure between 315 nm and 395 nm, UVB wavelengths measure between 280 nm and 315 nm, and UVC wavelengths measure between 100 nm and 280 nm. However, one skilled in the art will recognize these ranges are somewhat adjustable. For example, some embodiments may characterize wavelengths of 285 nm as UVC.

The light source 304 may be, for example, a fluorescent bulb, an LED, a low-pressure, e.g., mercury (Hg), bulb, or an excited dimer (excimer) lamp/laser. Combinations of different light sources could be used in some embodiments. Generally, the light source 304 is selected to ensure that the curing temperature does not exceed the temperature at which the ink 308 begins to sublime. For example, light source 304 of FIG. 3 is a UV LED lamp that generates low heat output and can be used for a wider range of former types. UV LED lamps are associated with lower power consumption, longer lifetimes, and more predictable power output.

Other curing sources and/or processes may also be used, such as epoxy (resin) chemistries, flash curing, and electron beam technology. One skilled in the art will appreciate that many different curing sources and/or processes could be adopted that utilize specific timeframes, intensities, rates, etc. The intensity may increase or decrease linearly or nonlinearly—e.g., exponentially, logarithmically. In some embodiments, the intensity may be altered using a variable resistor or alternatively by applying a pulse-width-modulated (PWM) signal to the diodes in the case of an LED light source.

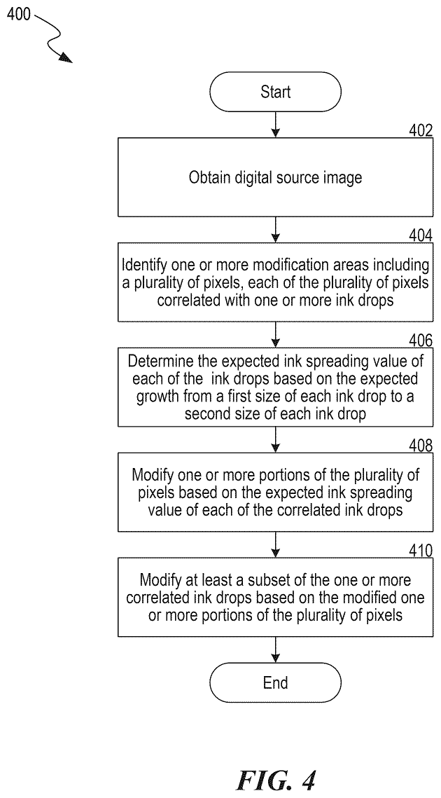

FIG. 4 is a flowchart of an example method 400 of modifying a digital source image to obtain a printed image, in accordance with one or more embodiments. In some embodiments, at least some steps of method 400 are performed by a printing system (e.g., printing system 200 of FIG. 2). In some embodiments, at least some steps of method 400 are performed by a computer system (e.g., computer system 500 of FIG. 5). Likewise, embodiments can include different and/or additional steps or perform the steps in different orders.

At 402, a digital source image is obtained. The digital source image can be in any format suitable for image processing and can be comprised of any combination of text, graphics, images, or other digital features. In some embodiments, the digital source image is obtained by converting (e.g., rendering) an image to a rasterized image using a raster image processor (RIP). For example, the digital source image can include a bitmap comprised of a plurality of pixels, in which the pixels represent discrete units of color associated with graphics, images, text, or other digital features of the digital source image.

At 404, one or more modification areas of the digital source image are identified. Each of the modification areas includes a plurality of discrete units (e.g., pixels), and each discrete unit is correlated with one or more ink drops. For example, one or more modification areas can include a plurality of edges that form the boundaries between different graphics, objects, and/or text of the digital source image. The edges include a plurality of pixels containing, for example, color and spacing information for each pixel. Each of the pixels that comprises the plurality of edges is correlated with one or more ink drops.

In some embodiments, each discrete unit that comprises an edge between a portion of colored text (e.g., part of a cyan-colored letter “A”) and a background color (e.g., yellow) contains color information for the part of the edge in which that pixel is located. In some embodiments, each of the discrete units contains information regarding the characteristics of the one or more ink drops associated or correlated with each discrete unit. For example, the discrete units can contain color, size, volume, and spacing information for associated or correlated ink drops. In some embodiments, the modification areas include substantially all or all of the digital source image.

At 406, an expected ink spreading value of each of the one or more ink drops is determined. The expected ink spreading value is representative of the anticipated dot gain (discussed above) of a given ink drop. The expected ink spreading value of each of the one or more ink drops is based on the difference between a first area of each ink drop when deposited (e.g., by an ink channel/color channel) on a printing substrate (e.g., a textile) and a second area of each ink drop when cured on the printing substrate (e.g., via a light source). For example, the expected ink spreading value can be determined by calculating the difference between the expected area of an ink drop of a given color when it is jetted or deposited onto a substrate (e.g., 5 picoliters for cyan, 5 picoliters for black, 5 picoliters for yellow, etc.) and the expected area of the ink drop when it is cured or dried on the substrate (e.g., 85 picoliters for cyan, 35 picoliters for black, 75 picoliters for yellow, etc.) to obtain an expected ink spreading value for each ink drop of a given color (e.g., 80 picoliters for cyan, 30 picoliters for black, 70 picoliters for yellow, etc.).

In some embodiments, the expected ink spreading value of a given ink drop is based at least in part on the color of the ink due to the particular ink spreading characteristics of each color. In some embodiments, the expected ink spreading value is based at least in part on the volume of the ink drop. In additional embodiments, the expected ink spreading value is based at least in part on the distance a given ink drop travels on a printing substrate before curing. For example, cyan can travel a distance D1, while black can travel a distance D4, as shown in FIG. 3 and discussed above. In some embodiments, the expected ink spreading value of a given ink drop is based at least in part on the amount of time an ink drop spends on a printing substrate before curing since more time allows for more spreading to occur. In some embodiments, the expected ink spreading value is based at least in part on the absorption and/or absorption rate of a given ink by a given printing substrate. For example, the absorption of ink of a given color into a photographic media can be relatively low (or none). Alternatively, the absorption of ink of a given color into an untreated media can be high. In some embodiments, the expected ink spreading value of a given ink drop can be based at least in part on the type of ink (e.g., liquid ink, solid ink, toner, ribbon ink, UV ink, and/or any kind of pigment-based ink including water-based ink).

At 408, one or more portions of the plurality of discrete units are modified based on the expected ink spreading value of each of the one or more correlated ink drops. In some embodiments, the color, volume, size, spacing, etc. information contained in each discrete unit can be modified. For example, based on an expected ink spreading value of 80 picoliters for cyan-colored ink drops, discrete units containing information correlated with cyan-colored ink drops can be modified. In some embodiments, a halftone is applied that can modify the spacing and/or volume information contained in the discrete units based on the expected ink spreading values for each ink drop and/or ink channel. In some embodiments, one or more halftones are applied to each channel to create a uniform ink drop spreading pattern or performance for each color and/or ink channel based on the expected ink spreading values. In some embodiments, a different halftone is applied to each ink drop color and/or ink channel.

In some embodiments, the discrete units are modified to increase the space between the correlated ink drops for a given color. In additional embodiments, the discrete units are modified to decrease or increase the volume of the correlated ink drops for a given color. In additional embodiments, the number of discrete units in a given space can be reduced (e.g., erosion). In yet further embodiments, the number of ink drops of a given color for a given discrete unit can be reduced, eliminated, and/or substituted for ink drops of a different color.

At 410, one or more correlated ink drops are modified based on the modification applied to the discrete units. The characteristics of each of the ink drops (e.g., color, volume, spacing, etc.) can be modified and/or controlled by the information contained in the correlated discrete units. For example, modifying (e.g., increasing) the spacing information in a given discrete unit can modify (e.g., increase) the spacing of the correlated ink drops of a given color. In some embodiments, the ink drops of a given color for a given discrete unit can be reduced in volume by reducing the volume information contained in the discrete unit. For example, the volume of ink drops for cyan in a given discrete unit can be modified from 10 picoliters down to 5 picoliters. In such examples, ink drops of other colors (e.g., black) can remain at a previous volume (e.g., 10 picoliters).

In some embodiments, each of the ink drops correlated with each of the discrete units comprising a modification area is modified so as to create a uniform ink spreading pattern for each color. For example, an expected ink spreading value for cyan can be 80 picoliters, while an expected ink spreading value for black can be 30 picoliters, given a portion of the plurality of discrete units comprising a modification area. In order to create a uniform ink spreading pattern in the modification area, the volume information for cyan in the discrete units in the modification area can be decreased. Based on the decrease in volume information, the volume of each ink drop for cyan that correlates with the modified discrete units will be reduced. The result can be an ink spreading pattern where both cyan and black have ink spreading values of 30 picoliters. This provides, for example, greater clarity/sharpness to the modification area within the digital source image.

In some embodiments, the method 400 includes determining an observed ink spreading value of each of the one or more ink drops. For example, the observed ink spreading value can be based on the difference between an observed area (e.g., a third area) of each ink drop when deposited on the printing substrate and an observed area (e.g., a fourth area) of each ink drop when cured on the printing substrate. In some embodiments, the observed areas are determined by an inspection camera or other photographic and/or videographic device. In some embodiments, the one or more portions of the plurality of discrete units comprising the one or modification areas are modified (similar to the modifications discussed above) based on the observed ink spreading values of each of the one or more ink drops.

FIG. 5 is a block diagram illustrating a computer system to control an inkjet printing system, in accordance with one or more embodiments. Components of the example computer system 500 can be used to implement the systems 200, 300, and method 400 illustrated and described in more detail with reference to FIGS. 2, 3, and 4. At least some operations described with reference to FIG. 4 can be implemented on the computer system 500. Likewise, other embodiments include different and/or additional components or can be connected in a different way.

The computer system 500 can include one or more central processing units (“processors”) 502, main memory 506, non-volatile memory 510 (also referred to as non-transitory memory), network adapter 512 (e.g., network interface), video display 518, input/output devices 520, control device 522 (e.g., keyboard and pointing devices), drive unit 524 including a storage medium 526, and a signal generation device 530 that are communicatively connected to a bus 516. The bus 516 is illustrated as an abstraction that represents one or more physical buses and/or point-to-point connections that are connected by appropriate bridges, adapters, or controllers. The bus 516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”).

The computer system 500 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality system (e.g., a head-mounted display), or another electronic device capable of executing a set of instructions (sequential or otherwise) that specify action(s) to be taken by the computer system 500.

While the main memory 506, non-volatile memory 510, and storage medium 526 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 528. The terms “machine-readable medium” and “storage medium” shall also be taken to include any medium that is capable of storing, encoding, or carrying a set of instructions for execution by the computer system 500.

In general, the routines executed to implement the embodiments of the disclosure may be implemented as part of an operating system or a specific application, component, program, object, module, or sequence of instructions (collectively referred to as “computer programs”). The computer programs typically include one or more instructions (e.g., instructions 504, 508, 528) set at various times in various memory and storage devices in a computing device. When read and executed by the one or more processors 502, the instruction(s) cause the computer system 500 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory 510, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 512 enables the computer system 500 to mediate data in a network 514 with an entity that is external to the computer system 500 through any communication protocol supported by the computer system 500 and the external entity. The network adapter 512 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 512 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, as well as the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example, using italics and/or quotation marks. The use of highlighting has no influence on the scope and meaning of a term; the scope and meaning of a term are the same in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, but no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications may be implemented by those skilled in the art.

What is claimed is:

1. A method of obtaining a modified printed image from a digital source image, the method comprising:
obtaining the digital source image;
identifying one or more modification areas within the digital source image, the one or more modification areas including a plurality of pixels, each of the plurality of pixels correlated with one or more ink drops;
determining an expected ink spreading value of each of the one or more ink drops, wherein the expected ink spreading value of each of the one or more ink drops is based on the difference between a first area of each ink drop when deposited on a printing substrate and a second area of each ink drop when cured on the printing substrate, wherein the first and second areas are based at least in part on the color of the ink drop, and wherein the second area is greater than the first area;
modifying one or more portions of the plurality of pixels based on the expected ink spreading value of each of the one or more correlated ink drops; and
modifying the one or more correlated ink drops based on the modified one or more portions of the plurality of pixels;
wherein modifying the one or more correlated ink drops modifies the printed image.

2. The method of claim 1, wherein determining the expected ink spreading value of each of the one or more ink drops is further based at least in part on the amount of time each of the one or more ink drops remains uncured on the printing substrate.

3. The method of claim 1, wherein determining the expected ink spreading value of each of the one or more ink drops is further based at least in part on the distance between a plurality of ink channels and a light source configured to cure the one or more ink drops on the printing substrate.

4. The method of claim 1, wherein determining the expected ink spreading value of each of the one or more ink drops is further based at least in part on the printing substrate.

5. The method of claim 1, further comprising:
determining an observed ink spreading value of each of the one or more ink drops, wherein the observed ink spreading value is based on the difference between a third area of each ink drop when deposited on the printing substrate and a fourth area of each ink drop when cured on the printing substrate, wherein the third and fourth areas are observed, and wherein the fourth area is greater than the third area; and
modifying the one or more portions of the plurality of pixels based on the observed ink spreading values of each of the one or more ink drops.

6. The method of claim 1, wherein modifying the one or more correlated ink drops further includes decreasing the first area of the one or more correlated ink drops.

7. The method of claim 1, wherein modifying the one or more correlated ink drops further includes increasing the space between each of the correlated ink drops.

8. A method of obtaining a modified printed image from a source image, the method comprising:
obtaining a source image;
identifying one or more modification areas of the source image, the one or more modification areas including a plurality of discrete units, wherein each of the plurality of discrete units is correlated with at least one of a plurality of ink drops;
determining an amount of ink spreading of each of the plurality of ink drops, wherein the amount of ink spreading of each of the ink drops is based on the difference between a first area of each ink drop when deposited on a substrate and a second area of each ink drop when cured on the substrate, wherein the first and second areas are based at least in part on the color of the ink drop, and wherein the second area is greater than the first area;
modifying one or more portions of the plurality of discrete units based on the amount of ink spreading of each of the correlated ink drops; and
modifying the at least one of the plurality of ink drops correlated with each modified discrete unit based on the modified one or more portions of the plurality of discrete units;
wherein modifying the at least one of the plurality of ink drops modifies the printed image.

9. The method of claim 8, wherein determining the amount of ink spreading of each of the plurality of ink drops is further based at least in part on the amount of time the plurality of ink drops remains uncured on the substrate.

10. The method of claim 8, wherein determining the amount of ink spreading of each of the plurality of ink drops is further based at least in part on the distance between a plurality of ink channels and a light source configured to cure the plurality of ink drops on the substrate.

11. The method of claim 8, wherein determining the amount of ink spreading of each of the plurality of ink drops is further based at least in part on the substrate.

12. The method of claim 8, further comprising:
determining an observed amount of ink spreading of each of the plurality of ink drops, wherein the observed amount of ink spreading is based on the difference between a third area of each ink drop when deposited on the substrate and a fourth area of each ink drop when cured on the substrate, wherein the third and fourth areas are observed, and wherein the fourth area is greater than the third area; and
modifying the one or more portions of the plurality of discrete units based on the observed amount of ink spreading of each of the plurality of ink drops.

13. The method of claim 8, wherein modifying the at least one of the plurality of ink drops correlated with each modified discrete unit further includes decreasing the first area of each of the plurality of correlated ink drops.

14. The method of claim 8, wherein modifying the at least one of the plurality of ink drops correlated with each modified discrete unit further includes increasing the space between each of the plurality of correlated ink drops.

15. A system for obtaining a modified printed image from a digital source image, the system comprising:
a printing apparatus comprising:
a plurality of ink channels configured to deposit one or more ink drops;
a printing substrate configured to receive the one or more ink drops from the plurality of ink channels; and
a light source configured to cure the one or more ink drops deposited on the printing substrate;
a processor;
a memory; and
a non-transitory, computer-readable storage media storing instructions, which, when executed by the processor, cause the system to:
obtain a digital source image;
identify one or more modification areas within the digital source image, the one or more modification areas including a plurality of pixels, wherein each of the pixels is correlated with at least one of the one or more ink drops;
determine an expected ink spreading value of each of the one or more ink drops, wherein the expected ink spreading value of each of the one or more ink drops is based on the difference between a first area of each ink drop when deposited on the printing substrate and a second area of each ink drop when cured on the printing substrate, wherein the first and second areas are based at least in part on the color of the ink drop, and wherein the second area is greater than the first area;
modify one or more portions of the plurality of pixels based on the expected ink spreading value of each of the one or more correlated ink drops; and
modify the one or more correlated ink drops based on the modified one or more portions of the plurality of pixels;
wherein modifying the one or more correlated ink drops modifies the printed image.

16. The system of claim 15, wherein the non-transitory, computer-readable storage media further stores instructions, which, when executed by the processor, cause the system to:
determine the expected ink spreading value of each of the one or more ink drops based at least in part on the amount of time each of the one or more ink drops remains uncured on the printing substrate.

17. The system of claim 15, wherein the non-transitory, computer-readable storage media further stores instructions, which, when executed by the processor, cause the system to:
determine the expected ink spreading value of each of the one or more ink drops based at least in part on the distance between the plurality of ink channels and the light source.

18. The system of claim 15, wherein the non-transitory, computer-readable storage media further stores instructions, which, when executed by the processor, cause the system to:
determine the expected ink spreading value of each of the one or more ink drops based at least in part on the printing substrate.

19. The system of claim 15, wherein the non-transitory, computer-readable storage media further stores instructions, which, when executed by the processor, cause the system to:
modify the one or more correlated ink drops at least in part by decreasing the first area of the one or more correlated ink drops.

20. The system of claim 15, wherein the non-transitory, computer-readable storage media further stores instructions, which, when executed by the processor, cause the system to:
modify the one or more correlated ink drops at least in part by increasing the space between each of the correlated ink drops.
